(19) United States
(12) Patent Application Publication
(10) Pub. No.: US 2008/0118237 A1
(43) Pub. Date: May 22, 2008

(54) Auto-Zoom Mark-Up Display System and Method

(76) Inventors: Rainer Wegenkittl, Sankt Poelten (AT); Donald K. Dennison, Waterloo (CA); John J. Potwarka, Waterloo (CA); Lukas Mroz, Wien (AT); Armin Kanitsar, Wien (AT); Gunter Zeilinger, Wien (AT)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 11/562,733

(22) Filed: Nov. 22, 2006

(51) Int. Cl. G03B 17/00

(52) U.S. Cl. 396/76

(57) ABSTRACT

A system and method for allowing a user to selectively view an automatically zoomed region of a displayed initial viewable area. Typically, the automatically zoomed region is deployed by the user when placing mark-ups in the viewable area.. The automatically zoomed region may be displayed by itself, or it may be displayed simultaneously with an un-zoomed portion of the initial viewable area. After the user places a mark-up in the viewable area, the automatically zoomed region is closed, and the initial viewable area is returned to the displayed viewable area.

### FIELD

The exemplary embodiments described herein relate generally to an image display systems and methods and more particularly to a system and method for automatically zooming the display of an image.

### BACKGROUND

Commercially available image display systems in the medical field use various techniques to present medical images to a medical practitioner. For example, the images produced by modalities such as computed radiograph (CR), magnetic resonance imagery (MRI) and the like, can be displayed on a display terminal at a medical treatment site for review by a medical practitioner. The medical practitioner can use the displayed images to determine the presence or absence of a disease, tissue damage, etc.

One useful tool for a practitioner using an image display system is to apply mark-ups to make measurements of regions of interest. A mark-up is a visible handle applied to a point location within an image. A practitioner may place a mark-up or a series of mark-ups on an image to help them determine the dimensions of a suspicious or damaged area of tissue. A system and method that automatically calculates values such as surface area, or length, can greatly assist the practitioner in their determination and diagnosis of the observed area of the image.

A difficulty in using mark-ups in an image display system is that a region of interest may be significantly smaller than the overall initial size of the displayed image The precise outer dimensions of a region, or the location of a point of interest may be difficult to accurately locate. This leads to the practitioner having difficulty in accurately placing the mark-up(s) in the desired anatomical location(s). The practitioner may experience, amongst other things, inaccurate sizing results, a more difficult diagnosis process, or frustration with using the image display system.

One approach to alleviate some of these problems for the practitioner is to magnify or “zoom in” on the region of interest. The practitioner can then see in greater detail the anatomical location where they would like to place their mark-up(s). However, manual adjustment of the image display system can require a number of mouse manipulations slowing down the placing of mark-ups and leading to frustration, fatigue and errors by the practitioner. For example, manually zooming in on a region of interest can involve a substantial and cumbersome number of steps such as: displacing the cursor from the region of interest, activating the zooming function, applying zoom to the region of interest, selecting the markup entity, returning the cursor to region of interest to place the mark-up, un-zooming the region of interest etc.

Accordingly, a system and method that easily and automatically allows zooming of a region of interest when the user wants to place a mark-up on the image is desirable for a practitioner.

### SUMMARY

The embodiments described herein provide in one aspect a method for automatically zooming a region of an initial viewable area according to a zoom factor after a mark-up entity has been activated and then displaying the automatically zoomed region within a viewable area, said method comprising:

(a) determining whether the mark-up entity has been activated;

(b) if (a) is true, then determining whether to automatically zoom the region of the initial viewable area;

(c) if (b) is true, then determining and applying the zoom factor to the region of the initial viewable area; and

(d) displaying the automatically zoomed region within the viewable area.

The embodiments described herein provide in another aspect a system for displaying an automatically zoomed region of a viewable area on a diagnostic interface having a viewing tool interface with a mark-up entity, said system comprising:

(a) a memory for storing an initial viewable area, an automatically zoomed region, and a zoom factor associating said initial viewable area and said automatically zoomed region;

(b) a processor coupled to the memory said processor, said processor configured for:
i. determining whether the mark-up entity has been activated;
ii. if (i) is true, then determining whether to automatically zoom a region of the viewable area;
iii. if (ii) is true, then determining and applying the zoom factor to the region of the initial viewable area; and
iv. displaying the automatically zoomed region within the viewable area.

Further aspects and advantages of the embodiments described herein will appear from the following description taken together with the accompanying drawings.

### BRIEF DESCRIPTION OF THE DRAWINGS

For a brief understanding of the embodiments described herein, and to clarify how they may be carried out, reference is made, by way of example, to the following drawings showing exemplary embodiments:

FIG. 1 is a block diagram of an exemplary embodiment of an automatically zooming mark-up display system;

FIG. 2A is a schematic diagram illustrating in more detail an exemplary diagnostic interface of FIG. 1;

FIG. 2B is a schematic diagram illustrating in more detail an exemplary diagnostic interface of FIG. 1;

FIG. 2C is a schematic diagram illustrating in more detail an exemplary diagnostic interface of FIG. 1;

FIG. 2D is a schematic diagram illustrating in more detail an exemplary diagnostic interface of FIG. 1;

FIG. 2E is a schematic diagram illustrating in more detail an exemplary diagnostic interface of FIG. 1;

FIG. 3 is a flowchart diagram illustrating the general operational steps conducted by the automatically zooming mark-up display system of FIG. 1;

FIG. 4 is a flowchart diagram illustrating the operational steps associated with launching the auto-zoom function illustrated in FIG. 3; and

FIG. 5 is a flowchart diagram illustrating the operational steps associated with closing the auto-zoom function illustrated in FIG. 3.

It will be appreciated that for simplicity and clarity of illustration, elements shown in the figures have not necessarily been drawn to scale. Further, where considered appropriate, reference numerals may be repeated among the figures to indicate corresponding or analogous elements.

### DETAILED DESCRIPTION

It will be appreciated that for simplicity and clarity of illustration, where considered appropriate, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, and cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

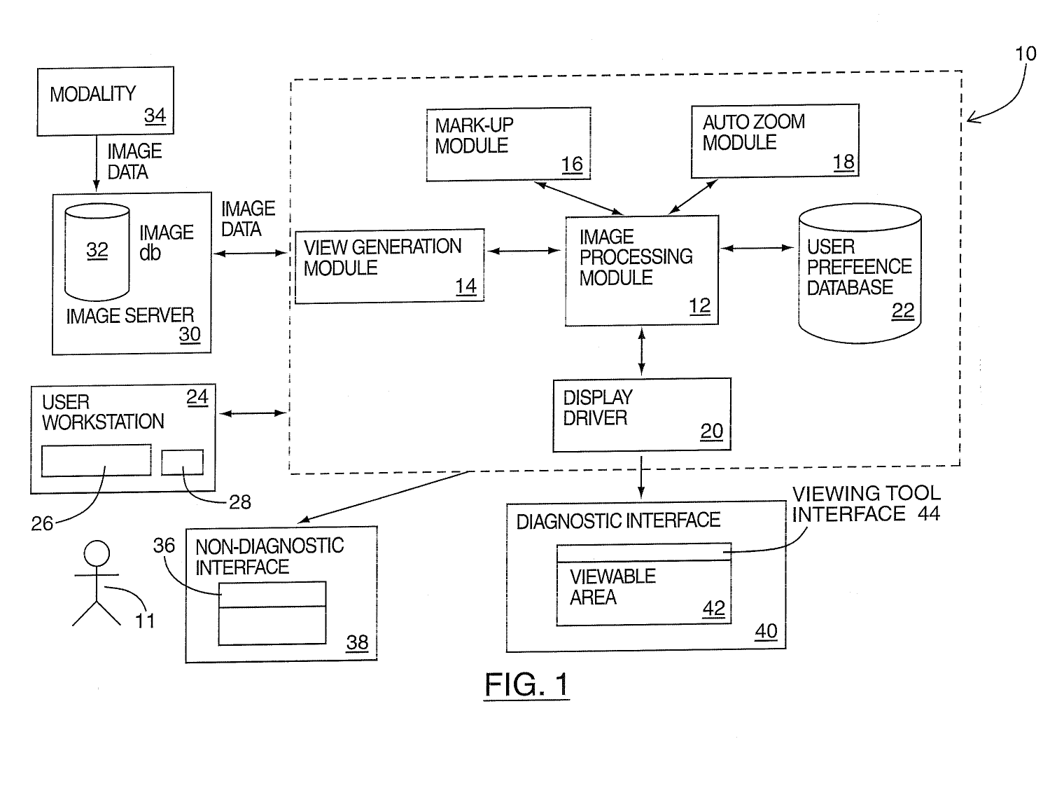

Reference is first made to FIG. 1, which illustrates the basic components of an exemplary embodiment of an automatically zooming mark-up display system 10. Automatically zooming mark-up display system 10 includes a mark-up module 16, an auto-zoom module 18, a view generation module 14, an image processing module 12, a display driver 20, and a user preference database 22. As shown, image data (such as medical images) displayed in the viewable area 42 of the diagnostic interface 40, is generated by a modality 34 and stored in an image database 32 on an image server 30, where they can be retrieved by the automatically zooming mark-up display system 10.

As discussed in more detail above, it should be understood that automatically zooming mark-up display system 10 may be implemented in hardware or software or a combination of both. Specifically, the modules of automatically zooming mark-up display system 10 are preferably implemented in computer programs executing on programmable computers each comprising at least one processor, a data storage system and at least one input and at least one output device. Without limitation the programmable computers may be a mainframe computer, server, personal computer, laptop, personal data assistant or cellular telephone. In some embodiments, automatically zooming mark-up display system 10 is implemented in software and installed on the hard drive of user workstation 24 and on image server 30, such that user workstation 24 interoperates with image server 30 in a client-server configuration. In other embodiments, the automatically zooming mark-up display system 10 can run from a single dedicated workstation that may be associated directly with a particular modality 34. In yet other embodiments, the automatically zooming mark-up display system 10 can be configured to run remotely on the user workstation 24 while communication with the image server 30 occurs via a wide area network (WAN), such as through the Internet.

Modality 34 may be any conventional image device used to generate image data that corresponds to patient medical exams. For example modality may be X-Ray equipment, computed tomography (CT) scanners, magnetic resonance (MR) images etc. A medical practitioner may use the image data generated by the modality 34 to make a medical diagnosis. For example, a practitioner may use the image and associated data to investigate the presence, absence, or size of a diseased part or an injury, or determine the characteristics of the diseased part or injury. Modality 34 may be positioned in a single location or facility, such as a medical facility, or may be accessed remotely. The modality 34 provides image data to the image server 30 in an analog or a digital format. For example, the digital image data may be in DICOM, bitmaps, JPEGS, GIFS, etc. The image server 30 then converts the image data into a digital format suitable for storage within the image database 32 on the image server 30.

As shown in FIG. 1, the user workstation 24 includes a keyboard 26 and a user-pointing device 28. A common example of a user-pointing device 28 is a mouse. The user workstation 24 can be implemented by any wired or wireless personal computer device with input and display means, for example: conventional personal computer, laptop competing device, personal digital assistant (PDA), etc User workstation 24 is operatively connected to the non-diagnostic interface 38 and the diagnostic interface 40. Automatically zooming mark-up display system 10 is used to alter the viewable area 42 formatting depending on user inputs through the user workstation 24. More detail is found in the paragraphs below.

The non-diagnostic interface 38 is optimized for image study selection and provides a user 11 with a patient list (not shown), and a study list 36. The patient list (not shown) provides a textual format listing of patients for which image studies are available for display. Study list 36 provides a textual format listing of image studies that are available for display for the selected patient. Typically, the user 11 will review study list 36 and select a listed image study for display.

When the user 11 selects an image study, the selected image study is displayed on the diagnostic interface 40. Other associated textual information, for example patient information, image resolution quality, date of image capture, etc, is simultaneously displayed within the study list 36 to assist the user 11 in selection of an image study for a particular patient. The non-diagnostic interface 38 may be implemented, for example, using a conventional color computer monitor. For this discussion, the term “image study” covers all different image types (for example series, studies, images, etc.) without exclusion.

The diagnostic interface 40 provides a high-resolution image display of a selected image study. The diagnostic interface 40 may be provided, for example, using a medical imaging quality display monitor with a relatively high resolution typically used for viewing CT and MR studies. Some examples being black and white “reading” monitors with resolutions of 1280-1024 and up.

The display driver 20 is a conventional display screen driver implemented using commercially available hardware and software. The display driver 20 ensures that images and text are displayed in a proper format on the diagnostic interface 40, and the non-diagnostic interface 38. The non-diagnostic interface 38 and the diagnostic interface 40 may be controlled and connected to the same processing platform. This processing platform may provide high speed processing, and may support two video cards (for example a regular video card for non-diagnostic interface 38 and a high performance video graphics card for diagnostic interface 40). However, in a further example there may be just one video card to support several interfaces, including the non-diagnostic interface 38, and the diagnostic interface 40.

Image processing module 12 coordinates the activities of the mark-up module 16, the auto-zoom module 18, the view generation module 14, the driver display 20 and the user preference database 22. The user 11 can use the user workstation 24 to select an image from the non-diagnostic interface 38. The image processing module 12 then retrieves the relevant image data from the image database 32, or image server 30. The image processing module 12 launches the view generation module 14, and the display driver 20, and displays the selected image in the viewable area 42 of the diagnostic interface 40. The image processing module 12 accesses the user preference database 22 for stored display parameters for displaying the diagnostic view of the selected image study in the viewable area 42. The image processing module 12 also accesses the user preference database 22 for the stored display parameters for the viewing tool interface 44 on the diagnostic interface 40.

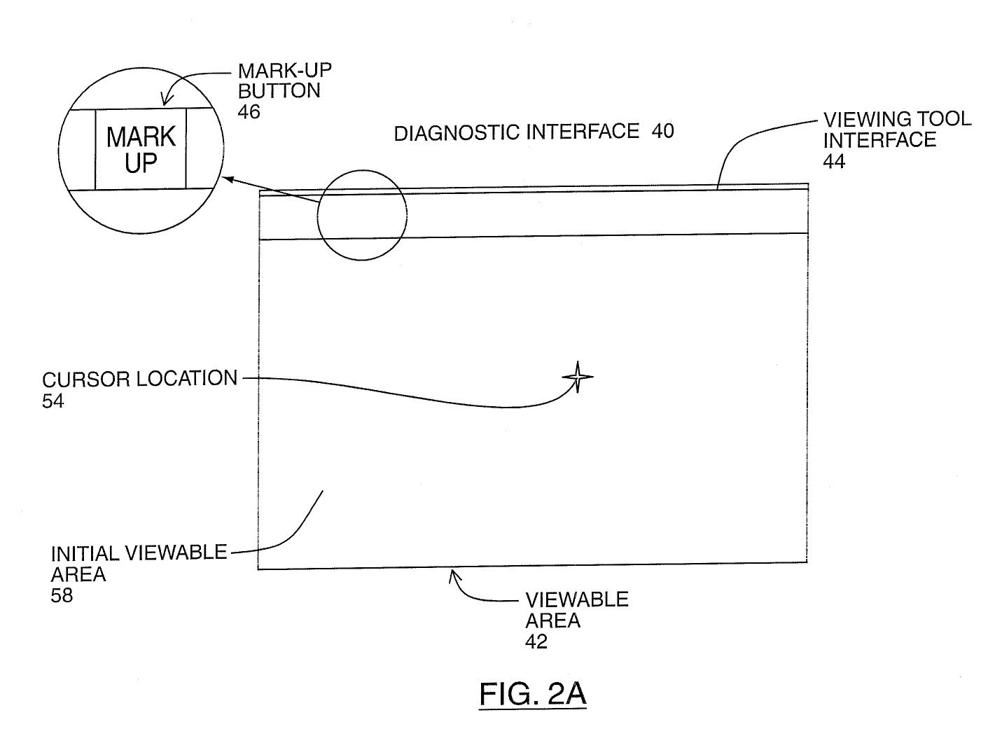

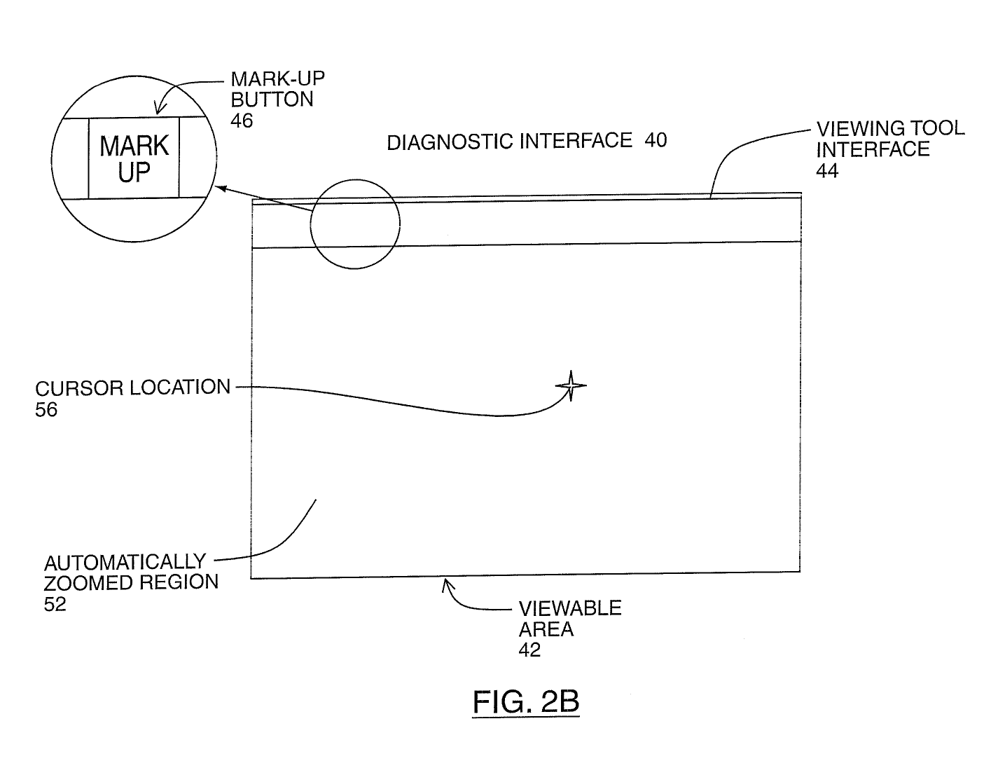

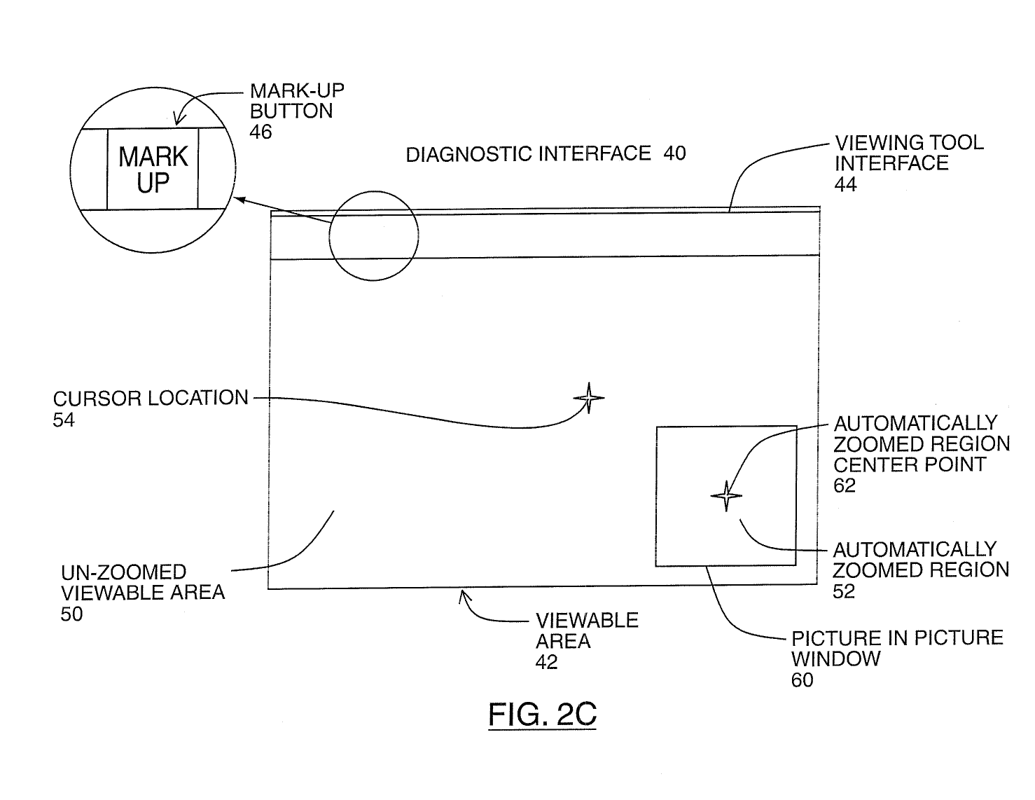

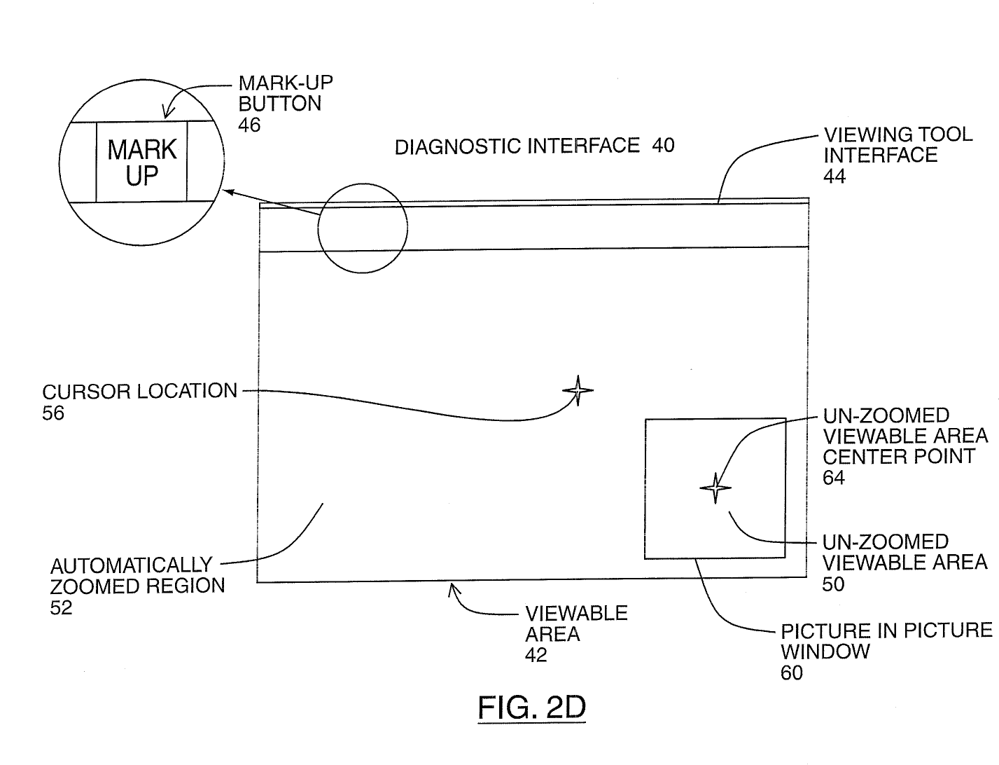

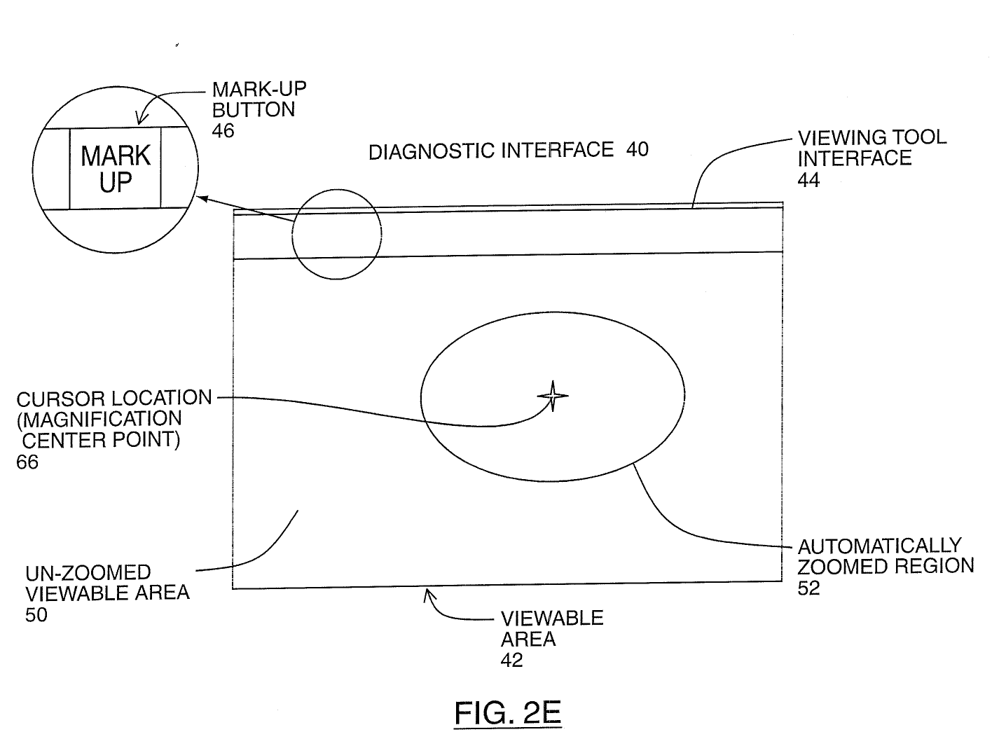

Reference is now made to FIGS. 1, and 2A to 2E. FIGS. 2A to 2E provide example Graphical User Interfaces (hereafter GUI) to illustrate the operation of the automatically zooming mark-up display system 10. They provide examples of how automatically zooming mark-up display system 10 can cause automatically zoomed region 52 to be displayed in the viewable area 42.

FIG. 2A shows the diagnostic interface 40 as it appears after the user 11 has selected an image study from the non-diagnostic interface 38 to be displayed. The diagnostic interface 40 comprises a viewable area 42 and a viewing tool interface 44. The viewable area 42 is the area where the image study selected by the user is displayed. It is from viewing the viewable area 42 that the user 11, for example a medical practitioner, can make observations, or diagnoses.

As shown, the viewing tool interface 44 may be located at the top of the diagnostic interface 40, or it may be located elsewhere, for example on the left or right side or bottom of the diagnostic interface 40. The viewing tool interface 44 allows the user 11 easy access to various image manipulation functions such as mark-ups, zooming, image rotation etc. The image manipulations are applied to the image displayed in the viewable areas 42.

A person skilled in the art would understand that the user workstation 24, and typically the user-pointing device 28 (for example a mouse), could be used to select an entity located on the viewing tool interface 44. The entity can be selected by the user 11 placing the cursor over desired button on the viewing tool interface 44 and activating the user-pointing device 28 (for example clicking on the mouse button). For example the user 11 could click on the mark-up entity button 46, located on the viewing tool interface 44 to activate the mark-up entity.

When a mouse is used as a user-pointing device 28, the default activation button stored in the user preference database 22 could be the left mouse button, however the user may adjust this to be any mouse button. This preference may be stored in the user database 22, and recalled when needed. The use of alternate mouse buttons is applicable to any situation in which a mouse is used in relation to the automatically zooming mark-up display system 10. A person skilled in the art would also be aware that this is only one exemplary method of activating the mark-up entity. For example, pull-down menus could also be used to activate the mark-up entity.

As shown in FIG. 2A, the diagnostic interface 40 may also display a cursor location 54, whose movements are linked to the movement of the user-pointing device 28 (for example a mouse). The cursor may be visible in the viewable area 42 as an arrow, or any other shape. The cursor, together with the user workstation 24, allow the user 11 to interact with the image study displayed in the viewable area 42, or to select a desired entity from the viewing tool interface 44, or for any task requiring a user 11 input. As shown in FIG. 2A, the viewable area 42 may contain only the initial viewable area 58 of the displayed image. The initial viewable area 58 should be understood to represent the image displayed in the viewable area 42 prior to use of the automatically zooming mark-up display system 10.

Reference is now made to FIG. 2B. FIG. 2B is similar to FIG. 2A, however, FIG. 2B displays an example of when an automatically zooming mark-up display system 10 is in use. A brief outline of the operation of the automatically zooming mark-up display system 10 is included here in order to facilitate explanation of the GUIs in FIGS. 2B to 2E. Additional details about the operation of the automatically zooming mark-up display system 10 are found in subsequent paragraphs below.

First, using a user-pointing device 28, or other means, the user 11 activates the mark-up entity. Typically, this is accomplished by the user 11 moving the cursor over, and selecting the mark-up entity button 46 on the viewing tool interface 44. The user 11 then moves the cursor back into the viewable area 42, and activates the user-pointing device 28, for example by pressing the mouse button. If the user 11 keeps the user-pointing device 28 activated, for example by continuing to press the mouse button, the automatically zooming mark-up display system 10 is activated. The cursor location 56 then becomes centered within the viewable area 42, and the image displayed in the viewable area 42 is an automatically zoomed region 52 of the initial viewable area 58.

In another example, the cursor location 56 does not become centered in the viewable area 42. When the user 11 activates the automatically zooming mark-up display system 10, as outlined above, the viewable area 42 does not become centered on the cursor location 56. The cursor location 56 may be located anywhere in the viewable region 42, and it remains in that location after the automatically zoomed region 52 is displayed. This example permits a smooth transition of the cursor location 56 between the initial viewable area 58 and the automatically zoomed region 52. In other words, the cursor location 56 does not change location, or “jump”, when the automatically zoomed region 52 is activated.

In addition, when displaying the automatically zoomed region 52, the zoom factor is applied as a smooth transition from the zoom in the initial viewable area 58 to the zoom in the automatically zoomed region 52, and not as a sudden jump. This smooth transition may be accomplished by use of an animation, or any other possibility as would be known to a person skilled in the art.

Once an automatically zoomed region 52 is displayed in the viewable area 42, the user 11 can pan around the displayed image, typically by moving the user-pointing device 28. In another example, the user 11 can move the cursor only within the automatically zoomed region 52 displayed within the viewable area 42. An automatic pan may also, for example, be introduced. The automatic pan may assist the user 11, by automatically moving the image away from an edge of the viewable area 42. This can be helpful when the user 11 activates the automatically zooming mark-up display system 10 while the cursor location 56 is near the edge of the viewable area 42, and it is difficult for the user to move the cursor to a desired location, which may be slightly off the screen. This permits the user 11 to better interact with the image, assisting the user in their mark-up placement.

In order to return (“snap-back”) to the initial viewable area 58, the user 11 typically deactivates the user-pointing device 28 (for example releasing the mouse button). Deactivation of the user-pointing device 28 triggers the placement of a mark-up. Upon deactivating the user-pointing device 28 the user 11 is returned, for example, to the diagnostic interface 40 shown in FIG. 2A, where the viewable area 42 again contains the initial viewable area 58 as it was prior to activating the automatically zooming mark-up display system 10. It should be apparent to the skilled user that different options of the above discussion are possible and these are only particular operational examples provided for illustration purposes.

FIGS. 2C to 2E show further examples of GUIs that could be generated by automatically zooming mark-up display system 10. They represent different manners of displaying the automatically zoomed region 52 in the viewable area 42. These additional GUIs allow the user 11 to view an automatically zoomed region 52 as well as an un-zoomed viewable area 50. This permits the user 11 to view a larger context than simply the automatically zoomed region 52, providing the user 11 with a broader view to improve, for example, the accuracy of their mark-up placement.

Referring now to FIG. 2C a picture in picture window 60 is displayed. When the user 11 activates the automatically zooming mark-up display system 10 (in a manner similar to that described above), the automatically zoomed region 52 appears only in the picture in picture window 60. The viewable area 42 not within the picture in picture window 60 displays the un-zoomed viewable area 50. The picture in picture window 60 displaying the automatically zoomed region 52 is centered on the automatically zoomed region center point 62, which is also the location of the cursor in the picture in picture window 60. The cursor may be simultaneously displayed in both the un-zoomed viewable area 50, as well as in the automatically zoomed region 52. The user 11 can then pan around the un-zoomed viewable area 50 displayed in the viewable area 42, with the automatically zoomed region 52 displayed in the picture in picture window 60 changing accordingly.

As discussed above for FIG. 2B, deactivation of the user pointing device 28 at any time triggers the placement of a mark-up, and the closing of the automatically zoomed region 52 as well as the picture in picture window 60. The diagnostic interface 40 then returns to the initial viewable area 58, as shown in FIG. 2A. A person skilled in the art will understand there are many possibilities in relation to the picture in picture window 60. For example when the automatically zoomed region 52 is closed, the picture in picture window 60 may remain and go blank, or it may display a previous image study etc. In addition, a person skilled in the art would understand that similar examples without the cursor being present or centered in the automatically zoomed region 52 or in the picture in picture window 60 are also possible.

Reference is now made to FIG. 2D, which is similar to FIG. 2C, with one significant difference. In FIG. 2D, the automatically zoomed region 52 is displayed in the viewable area 42 not contained in the picture in picture window 60, and the un-zoomed viewable area 50 is displayed in the picture in picture window 60.

Reference is now made to FIG. 2E, which shows a final example GUI. The automatically zoomed region 52 resembles a “magnifying glass” placed over a portion of the viewable area 42. Once the automatically zooming mark-up display system 10 is activated, an automatically zoomed region 52 (typically concentric, however it may be any shape) is created with the cursor location at its center point 66. The zoom factor may be, amongst other options, uniform within the automatically zoomed region 52. The zoom factor is the level of magnification applied to the initial viewable area 58, prior to being displayed as the automatically zoomed region 52. If the zoom factor is uniform, the area within the automatically zoomed region 52 is zoomed to the same level, and the un-zoomed viewable area 50 outside the automatically zoomed region 52 remains at its original zoom factor.

The zooming factor may also vary within the automatically zoomed region 52, for example, in a non-linear fashion. For example, the zoom factor may increase from the outer edge to the center point 66 of the automatically zoomed region 52. For example, the outer edge may have no zoom factor applied, and the center-point 66 may having the greatest zoom factor. A person skilled in the art would understand that these are only a few illustrative examples of possible a GUI using a “magnifying glass” type of automatically zoomed region 52 in diagnostic interface 40, and that many other possibilities are included in this description.

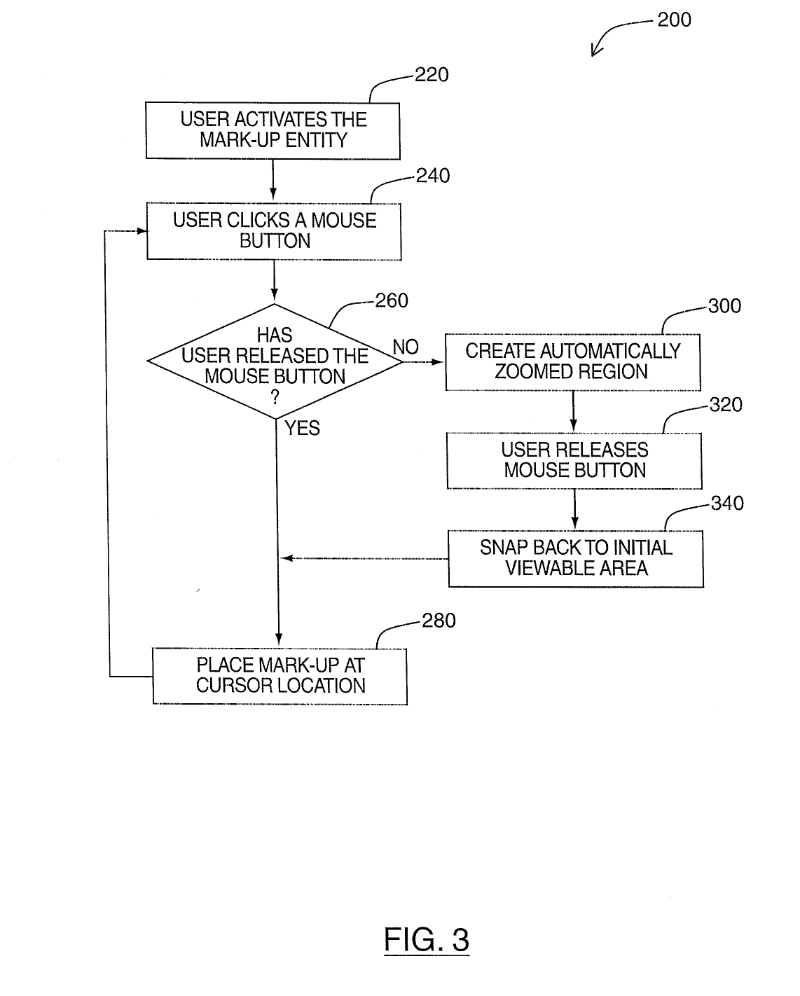

Reference is now to made to FIGS. 1, 2A to 2E and 3. Specifically, FIG. 3 illustrates the basic operational steps 200 executed by the automatically zooming mark-up display system 10. At step (220), the image processing module 12 of the automatically zooming mark-up display system 10 polls whether the user 11 has activated the mark-up entity. The user 11 may activate the mark-up entity in a number of ways. For example, the user 11 may select the mark-up entity button 46 on the viewing tool interface 44 with the user-pointing device 28. Alternatively, as is known by those skilled in the art, a user 11 may use a pull-down menu (not shown) to activate the mark-up entity. Activation of the mark-up entity launches the mark-up module 16 of the automatically zooming mark-up display system 10

At step (240), the user activates the user-pointing device 28, for example by clicking on a mouse button. Once the mark-up entity has been activated, activation of the user-pointing device 28 can be used to place a mark-up at the cursor location in the viewable area 42.

At step (260) the image processing module 12 polls whether after activating the user-pointing device 28, the user 11 has maintained the activation of the user-pointing device 11. For example, after clicking on the mouse button has the user 11 continued to press the mouse button (continued activation), or has the user 11 released the mouse button (deactivation). A person skilled in the art would know that activation of the user-pointing device 28, for example a mouse, could be achieved in a number of ways. These include, by way of example in reference to a mouse, clicking on the left or right mouse button.

If the automatically zooming mark-up display system 10 determines that the user-pointing device 28 has been deactivated, then the auto-zoom module 18 is not launched. In this case, the image processing module 12 proceeds to step (280).

At step (280) a mark-up is placed in the viewable area 42. Upon deactivation of the user-pointing device 28 the image processing module 12 accesses the launched mark-up module 16, the driver display 20 and the view generation module 14. The image processing module 12 determines the cursor's location in the viewable area 42 through the display driver 20. The image processing module 12 then selects the pixel nearest the cursor location, and places a mark-up on that pixel. Using the view generation module 14, and the display driver 20, the image processing module 12 then displays the mark-up on that pixel in the viewable area 42.

In another example, every image study is given a 3-D virtual patient coordinate system, typically in millimeters, for defining points within the image study. The 3-D virtual patient coordinate system permits definition of an image study, and points therein, by an X, Y and Z value. When a user 11 deactivates the user-pointing device 28, the image processing module 12 accesses the launched mark-up module 16, the driver display 20 and the view generation module 14 to determine the virtual patient coordinate location of the cursor, and to place and display a mark-up at that virtual patient coordinate location. Use of a virtual patient coordinate system assists in making the mark-up viewable no matter what angle or view of the image study is displayed in the viewable area 42 of the diagnostic interface 40.

If the user 11 does not deactivate the user-pointing device 28 then the image processing module 12 proceeds to step (300) to create an automatically zoomed region 52 For example in the case of a mouse, if the user 11 continues to press on a mouse button, then the image processing module 12 proceeds to step (300) to create an automatically zoomed region 52. The determination of whether to create an automatically zoomed region 52, decided at step (260), can occur instantly when the user 11 first activates the user-pointing device 28. Optionally, there can be a short delay, of, for example, a fraction of a second, before the determination is made. A short delay permits a user 11 to place a mark-up without launching the auto-zoom module 18 by, for example, clicking and rapidly releasing a mouse button. When a short delay is used the user 11 can access the automatically zooming mark-up display system 10 by pressing and holding the mouse button, launching the auto-zoom module 18. The length of the delay is stored in and retrieved from the user preference database 22. The delay value may be a default, or a value entered by the user 11.

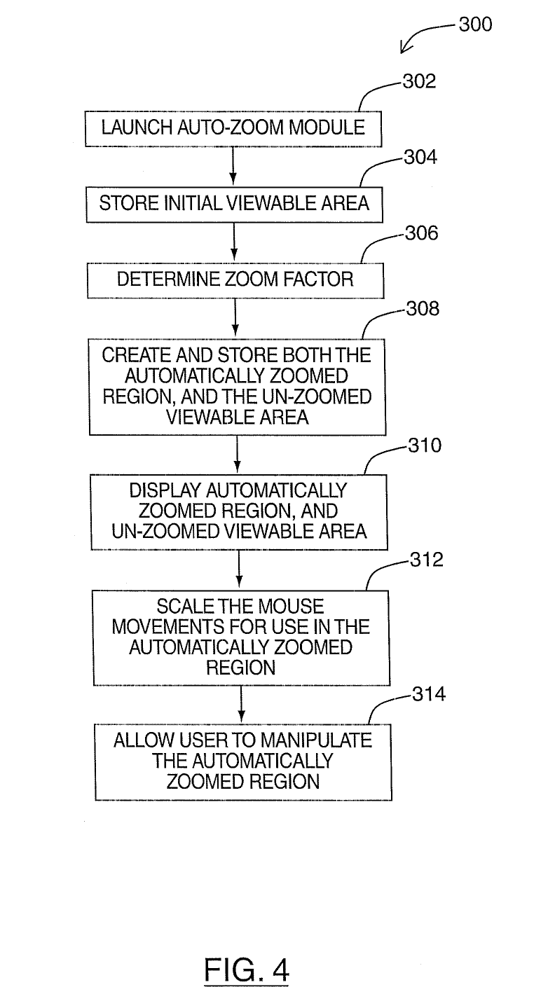

Reference is now made to FIG. 4, which illustrates in more detail the operational step 300, namely the launching of an automatically zoomed region 52. First at step (302) the image processing module 12 launches the auto-zoom module 18. Next, at step (304) the image processing module 12 stores the initial viewable area 58 in the user preference database 22, or on the image server 30.

Next, at step (306), the image processing module 12 determines the appropriate zoom factor to apply to the initial viewable area 58. This determination may be made, for example, by accessing a default or user entered value stored in the user preference database 22. Alternatively, the user 11 may enter the zoom factor at the time of launching the auto-zoom module 18.

In another example, the zoom factor may be determined by the image processing module 12 based on a feature of the initial viewable area 58, or on a feature of a component of the diagnostic interface 40. Features in the initial viewable area 58 which may help determine the zoom factor include the type of data comprising the image study, or the “base” magnification (discussed below) of the initial viewable area 58, prior to activation of the automatically zooming mark-up display system 10. A feature of the diagnostic interface 40 that may influence the zoom factor determination is the resolution of the diagnostic interface 40, or specifically the physical size of the diagnostic interface 40 pixels. A person skilled in the art would understand that these are simply a few illustrative examples and there are other possible features, both in relation to the initial viewable area 58, and the diagnostic interface 40, which may be used to determine the zoom factor.

In one example, the zoom factor may be a percentage of the “base” magnification. In a further example, if the “base” magnification is significant (i.e. beyond a default, or a user 11 entered threshold) the image processing module 12 may determine that no zoom factor should be applied, or that there should be no automatically zoomed region 52 displayed.

As discussed previously, the zoom factor determines the level of magnification applied to the initial viewable area 58 to yield the automatically zoomed region 52. The initial viewable area 58 typically has a “base” magnification applied to it relative to the data stored in the image database 32, in order to size the initial viewable area 58 to fit within the viewable area 42. The zoom factor applied to the automatically zoomed region 52 may be relative to the “base” magnification of the initial viewable area 58. For example, a 1500×2000 CR image in a 1000×1000 resolution diagnostic interface 40, may have a base magnification of 0.5. The zoom factor to be applied may be 200%, bringing the magnification to 1.0 for the automatically zoomed region 52. Alternatively, the zoom factor may be a value independent of the base magnification.

At step (308), the zoom factor determined above is applied to the initial viewable area 58 to create an automatically zoomed region 52. As previously discussed the cursor location does not move when the automatically zoomed region 52 is displayed in the viewable area 42. The cursor therefore does not “jump” when the display of the automatically zoomed region 52 appears.

The portion of the initial viewable area 58 not included in the automatically zoomed region 52 is the un-zoomed viewable area 50. Typically no zoom factor is applied to un-zoomed viewable area 50. Both the automatically zoomed region 52, and the un-zoomed viewable area 50 are stored by the image processing module in the user preference database 22, or on the image server 30.

At step (310) the automatically zoomed region 52 is displayed. In addition, as previously mentioned there may be an animation used to apply the zoom factor to the automatically zoomed region 52 in a smooth fashion, so the transition from the initial viewable area 58 is not a sudden change. As discussed earlier, and as seen in FIGS. 2A to 2E, there are a number of manners of displaying the automatically zoomed region 52 in the viewable area 42. For example, the automatically zoomed region 52 may be displayed as in FIG. 2B in the whole viewable area 42, or as in FIGS. 2C and 2D using a picture in picture window 60, or as in FIG. 2E using a “magnifying glass” automatically zoomed region 52. A person skilled in the art would understand that these are only a few examples, and there are other possibilities covered by this disclosure.

The manner of displaying the automatically zoomed region 52 in the viewable area 42 may be a default setting, or the user may select it at any time while using of the automatically zooming mark-up display system 10. The default, or user entered setting may be stored in the user preference database 22. In addition, the manner of displaying the automatically zoomed region 52 in the viewable area 42 may be determined by the image processing unit based on, for example, a characteristic of the image study, (for example CR or MRI etc.), or the current diagnostic interface 40 layout, for example viewing tool interface 44 location etc.

The automatically zoomed region 52 may have the cursor located at its center, or the cursor may remain at the location where the user-pointing device 28 is activated. As previously discussed, the image may auto-pan to assist the user 11 in using the automatically zoomed region 52.

At step (310), the un-zoomed viewable area 50 may also be displayed in the viewable area 42. For example, in FIGS. 2C to 2E the un-zoomed viewable area 50 is displayed in the portion of the viewable area 42 not occupied by the automatically zoomed region 52. In some other embodiments, for example FIG. 2B, the un-zoomed viewable area 50 is not displayed in the viewable area 42. In that example the automatically zoomed region 52 occupies the whole viewable area 42.

The un-zoomed viewable area 50 may also not be linked to the initial viewable area 58. For example, the un-zoomed viewable area 50 may display a default image stored in the image database 32, image server 30, or user preference database 22. Alternatively the un-zoomed viewable area 50 may display a portion of the initial viewable area 58 at a zoom factor different than that of the automatically zoomed region 52. Any settings related to the display of the un-zoomed viewable area 50 could be stored in the user preference database 22.

At step (312) the auto-zoom module 18 may scale the movement of the user-pointing device 28, for example the mouse. This scaling takes place in proportion to the zoom factor applied to the automatically zoomed region 52. For example, if the automatically zoomed region 52 has ten pixels per unit area, whereas the initial viewable area 58 has one pixel per unit area, the user-pointing device 28 will be oversensitive to the user's movements of the user-pointing device 28. The movements are therefore scaled, or “slowed down” in order for the user 11 to be able to maintain a similar level of control over the use of their user-pointing device 28 in the automatically zoomed region 52 Scaling of mouse movements is well known to a person skilled in the art.

The scaling of the user-pointing device 28 movements may also be adjusted to help the user 11 with accurate placement of mark ups in the automatically zoomed region 52. For example, the user-pointing device 28 movements may be scaled or “slowed down” to a level lower than that initially experienced by the user 11 in the initial viewable area 58, in order to permit the user to have greater control in the placement of a mark-up in the viewable area 42. The level of scaling can be a default setting, or may be input by the user 11. Any settings associated with the scaling, including the user-pointing device 28 scaling prior to the launching of the auto-zoom module 18, can be stored and retrieved from the user preference database 22.

At step (314) the user 11 can manipulate the image displayed in the automatically zoomed region 52. Some common examples include allowing the user 11 to pan the automatically zoomed region 52. The user 11 can pan by simply moving the user-pointing device 28 within the image. The images displayed in the automatically zoomed region 52, and also the un-zoomed viewable area 50 if applicable, adjust accordingly. This allows the user 11 to more easily maneuver around the image to any region of interest. In another example the user 11 may only be permitted to move the cursor within the displayed un-zoomed viewable area 42.

At step (314) another user 11 manipulation to the automatically zoomed region 52 is alteration of the zoom factor applied to the automatically zoomed region 52 As an example, the user may adjust the zoom factor applied to the automatically zoomed region 52 by using the mouse-wheel of a mouse, or any part of a user workstation 24. Regarding the mouse-wheel, the user 11 can rotate it one way or another to increase or decrease the zoom factor of the automatically zoomed region 52. The zoom factor can be increased in default increments, or in increments set by the user. Default increments, or those input by the user can be stored in the user preferences database 22. This permits the user to have further control over the automatically zoomed region 52, improving their ability to use the image more effectively.

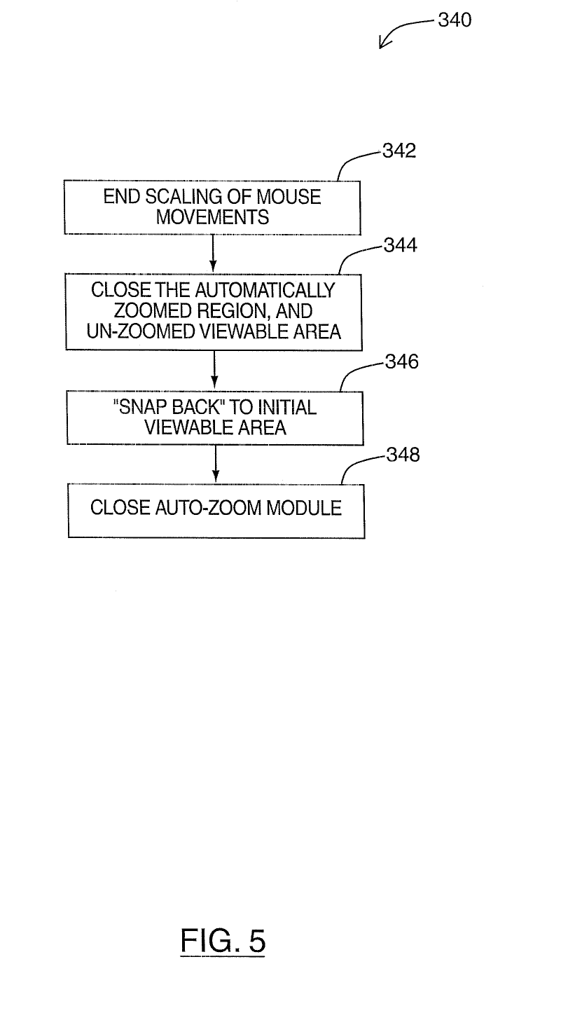

Reference is once again made to FIG. 3. At step (320) the user deactivates the user-pointing device 28, for example, by releasing the pressed the mouse button. After release of the mouse button, the auto-zoom module 18 begins the process of closing. The steps in closing the auto-zoom module 18 are discussed in more detail in relation to FIG. 5, below.

Reference is now made to FIG. 5 which illustrates in more detail the operational step 340 of FIG. 3. At step (342) any scaling that was applied to the movements of the user-pointing device 28, for example a mouse, are ended. The scaling applied to the movements of the user-pointing device 28 prior to launching the auto-zoom module 18 are recalled from the user preference database 22, and are reapplied to user-pointing device 28.

At step (344) the automatically zoomed region 52, and the un-zoomed viewable area 50 within the viewable area 42 are closed. At step (346) the initial viewable area 58 is recalled from the user preference database 22, and displayed in the viewable area 42, similar to FIG. 2. The viewable area 42 is therefore “snapped back” to the initial viewable area 58. This places the user 11 back at the position from which they started, prior to activating the automatically zooming mark-up display system 10. Optionally, the viewable area 42 can “snap back” to an image different than the initial viewable area 58. This may be for example, an image stored in the image server 30, or on the user preference database 22, or it may be the initial viewable area 58 with a preset or user entered level of zoom applied. At step (348) the auto-zoom module is closed.

Referring again to FIG. 3, after step (340) where the viewable area is “snapped back” to the initial viewable area 58, at step (280) a mark-up is placed in the viewable area 42 in accordance with the earlier discussion related to placing a mark-up. Following step (280) the image processing module 12 then polls again to see if the user-pointing device 28 is activated. If the user-pointing device 28 is activated the steps discussed above are repeated. The polling of the image processing module 12 continues until the mark up entity is deactivated.

While the various exemplary embodiments of the automatically zooming mark-up display system 10 have been described in the context of medical image management in order to provide an application-specific illustration, it should be understood that the automatically zooming mark-up display system 10 could also be adapted to any other type of image or document display system.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method for automatically zooming a region of an initial viewable area according to a zoom factor after a mark-up entity has been activated and then displaying the automatically zoomed region within a viewable area, said method comprising:
(a) determining whether the mark-up entity has been activated;
(b) if (a) is true, then determining whether to automatically zoom the region of the initial viewable area;
(c) if (b) is true, then determining and applying the zoom factor to the region of the initial viewable area; and
(d) displaying the automatically zoomed region within the viewable area.

2. The method of claim 1, further comprising:
(e) defining an un-zoomed viewable area as the portion of the initial viewable area that falls within the viewable area but outside the automatically zoomed region; and
(f) displaying the un-zoomed viewable area.

3. The method of claim 1, further comprising displaying a picture in picture window within the viewable area.

4. The method of claim 1, further comprising placement of the mark-up in the viewable area.

5. The method of claim 1, wherein a manner of displaying the automatically zoomed region in the viewable area is determined based a characteristic an image study.

6. The method of claim 1, wherein a manner of displaying the automatically zoomed region in the viewable area is determined based on a diagnostic interface layout.

7. The method of claim 1, wherein the zoom factor is provided by a user.

8. The method of claim 1, wherein the zoom factor is determined based on a feature of the initial viewable area.

9. The method of claim 1, wherein the zoom factor is determined based on a feature of a diagnostic interface.

10. The method of claim 1, further comprising:
(g) ceasing display of the automatically zoomed region;
(h) displaying the initial viewable area; and
(i) placement of a mark-up in the viewable area.

11. A computer-readable medium upon which a plurality of instructions are stored, the instructions for performing the steps of the method as claimed in claim 1.

12. A system for displaying an automatically zoomed region of a viewable area on a diagnostic interface having a viewing tool interface with a mark-up entity, said system comprising:
(a) a memory for storing an initial viewable area, an automatically zoomed region, and a zoom factor associating said initial viewable area and said automatically zoomed region;
(b) a processor coupled to the memory, said processor configured for:
i. determining whether the mark-up entity has been activated;
ii. if (i) is true, then determining whether to automatically zoom a region of the viewable area;
iii. if (ii) is true, then determining and applying the zoom factor to the region of the initial viewable area; and
iv. displaying the automatically zoomed region within the viewable area.

13. The system of claim 12, wherein the processor is further configured for:
(c) defining an un-zoomed viewable area as the portion of the initial viewable area that falls within the viewable area but outside the automatically zoomed region; and
(d) displaying the un-zoomed viewable area;
wherein the memory stores the un-zoomed viewable area.

14. The system of claim 12, wherein a manner of displaying the automatically zoomed region in the viewable area is determined based a characteristic an image study.

15. The system of claim 12, wherein a manner of displaying the automatically zoomed region in the viewable area is determined based on a diagnostic interface layout.

16. The system of claim 12, wherein the zoom factor is input by a user.

17. The system of claim 12, wherein the zoom factor is determined based on a feature of the initial viewable area.

18. The system of claim 12, wherein the zoom factor is determined based on a feature of the diagnostic interface

19. The system of claim 12, wherein the processor is further configured for displaying a picture in picture window.

20. The system of claim 12, wherein the processor is further configured for:
(e) closing the automatically zoomed region;
(f) displaying the initial viewable area;
(g) placing a mark-up.
